(19) United States
(12) Patent Application Publication
(10) Pub. No.: US 2012/0047752 A1
(43) Pub. Date: Mar. 1, 2012

(54) Mower Blade Attachment

(76) Inventor: Todd HOFMANN, Saskatoon (CA)

(21) Appl. No.: 12/873,732

(22) Filed: Sep. 1, 2010

(51) Int. Cl. B26B 7/00

(52) U.S. Cl. 30/275.4; 30/276

(57) ABSTRACT

A bolt for attaching a blade to a rotating blade carrier has a conical shoulder section with a conical wall tapering inward from bottom to top and a shoulder top edge above the conical shoulder section. A shank extends upward from the top shoulder edge, and is configured to extend through a shank hole in the carrier, and the shoulder top edge extends laterally outward from part of the shank. A threaded portion extends upward from the shank. A blade defines a vertical mounting hole with a conical portion with a slope corresponding to the conical portion off the bolt.

This invention is in the field of rotary mowers, and in particular a bolt for attaching a blade to the blade assembly of a rotary mower.

### BACKGROUND

In a typical rotary mower, a drive rotates a vertical shaft extending downward through the mower deck, and blade assembly is attached to the vertical shaft under the deck. The blade assembly comprises a rotating blade carrier, such as a blade pan or a blade arm, fixed to the shaft, and a plurality of blades pivotally attached to the carrier about vertical axes. The blades are attached to the carrier by blade bolts configured so that the bolts are secured and fixed to the carrier but the blades can pivot freely on the fixed bolts. Thus when the carrier is rotated at high speed, the blades extend outward to their cutting orientation and cut vegetation but if an obstruction is encountered, the blade can swing back about the bolt. Damage to the blades and shock to the blade assembly and driveline are thus reduced.

A conventional blade bolt is described in Canadian Patent Application Number 2,477,180 of Toth. The bolt has a head and shoulder, shank and threaded sections extending from the head. The bolt extends upward through a mounting hole in the blade and the top edge of the shoulder bears against the bottom surface of the carrier while the shank extends through a shank hole in the carrier. The shank is slightly shorter than the thickness of the carrier such that a nut can threaded on the threaded end of the bolt above the top surface of the carrier and tightened to clamp the top edge of shoulder of the bolt against the bottom surface of the carrier and fix the bolt with respect to the carrier.

The shank and shank hole are configured with corresponding corners so that the shank is prevented from turning in the shank hole, thereby allowing the nut to be tightened. It is thus not necessary to hold the head of the bolt in order to tighten the nut, as with a conventional bolt, and thus facilitates installation. The head of the bolt can also be rounded and smooth without corners to pass more easily through thick vegetation as the blade assembly rotates, thereby reducing the power required to rotate the blade assembly.

The blade has a thickness slightly less than the length of the shoulder portion of the blade bolt such that the horizontally oriented blade can spin freely on the vertically oriented shoulder between the head of the bolt and the carrier. The head of the bolt thus supports the blade vertically, and the shoulder of the bolt supports the blade horizontally. During operation the inner walls of the mounting hole in the blade bear against the shoulder of the bolt, and the bottom surface of the blade adjacent to the mounting hole bears against the top surface of the head of the bolt. As the blade pivots with respect to the fixed bolt, wear occurs on the shoulder and head of the bolt.

### SUMMARY OF THE INVENTION

It is an object of the present invention to provide a bolt for attaching a blade to the blade assembly of a rotary mower that overcomes problems in the prior art.

In a first embodiment the present invention provides a bolt for attaching a blade to a rotating blade carrier of a rotary mower. The bolt comprises a conical shoulder section at a bottom portion of the bolt, wherein a conical wall of the shoulder section tapers inward from a bottom edge thereof to a top edge thereof such that a diameter of the bottom edge of the conical wall is greater than a diameter of the top edge of the conical wall, and a shoulder top edge above the conical shoulder section. A shank extends upward from the top shoulder edge, and is configured to extend through a shank hole in the carrier, and at least a portion of the shoulder top edge extending laterally outward from at least a portion of the shank. A threaded portion extends upward from the shank at a top end of the bolt.

In a second embodiment the present invention provides a blade for attachment to a rotating blade carrier of a rotary mower. The blade comprises a top surface and a bottom surface, and defines a mounting hole extending substantially vertically from the bottom surface of the blade to the top surface of the blade. At least a portion of the blade mounting hole is a conical portion wherein a conical wall of the conical portion tapers inward from a bottom edge thereof to a top edge thereof, such that the bottom edge of the conical wall has a diameter that is larger than a diameter of the top edge of the conical wall.

In a third embodiment the present invention provides a blade assembly for a rotary mower. The assembly comprises a rotating blade carrier, and a blade defining a blade mounting hole extending substantially vertically from a bottom surface of the blade to a top surface of the blade with at least a portion of the blade mounting hole being a conical portion, wherein a conical wall of the conical portion tapers inward from a bottom edge thereof to a top edge thereof, such that the bottom edge of the conical wall has a diameter that is larger than a diameter of the top edge of the conical wall. A bolt extends upward through the blade mounting hole, the bolt comprising a conical shoulder section at a bottom portion of the bolt wherein a conical wall of the conical shoulder section has substantially the same slope as the conical wall of the of the conical portion of the blade mounting hole such that the conical wall of the conical shoulder section bears against the conical wall of the conical portion of the blade mounting hole to support the blade vertically and horizontally. A shoulder top edge above the conical shoulder section bears against a bottom side of the blade carrier above the top surface of the blade such that the blade pinots freely on the bolt. A shank extends upward from the shoulder top edge through a corresponding shank hole in the blade carrier. A threaded portion extends upward from the shank above a top side of the blade carrier, and a nut is threaded onto the threaded portion of the bolt and tightened to clamp the blade carrier between the nut and the shoulder top edge.

The bolt, blade, and blade assembly provide an increased bearing surface supporting the blade with resultant reduced wear, and an assembly with where the bottom surface of the mounted blade is flat and the bolt is recessed inside the blade, reducing power requirements and the risk of damage.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic sectional side view of a bolt and blade of the prior art;

FIG. 2 is schematic side view of a blade assembly of the prior art with the bolt and blade of FIG. 1;

FIG. 3 a schematic sectional side view of an embodiment of a bolt and blade of the present invention;

FIG. 4 is a side view of the bolt of FIG. 3;

FIG. 5 is an end view of the bolt of FIG. 3;

FIG. 6 a schematic sectional side view of an alternate embodiment of a bolt and blade of the present invention;

FIG. 7 is a side view of the bolt of FIG. 6;

FIG. 8 is a perspective view of the bolt of FIG. 6;

FIG. 9 is a schematic side view of an embodiment of blade assembly of the present invention;

FIG. 10 a schematic sectional side view of a further alternate embodiment of a bolt and blade of the present invention;

FIG. 11 is a side view of the bolt of FIG. 10.

### DETAILED DESCRIPTION OF THE ILLUSTRATED EMBODIMENTS

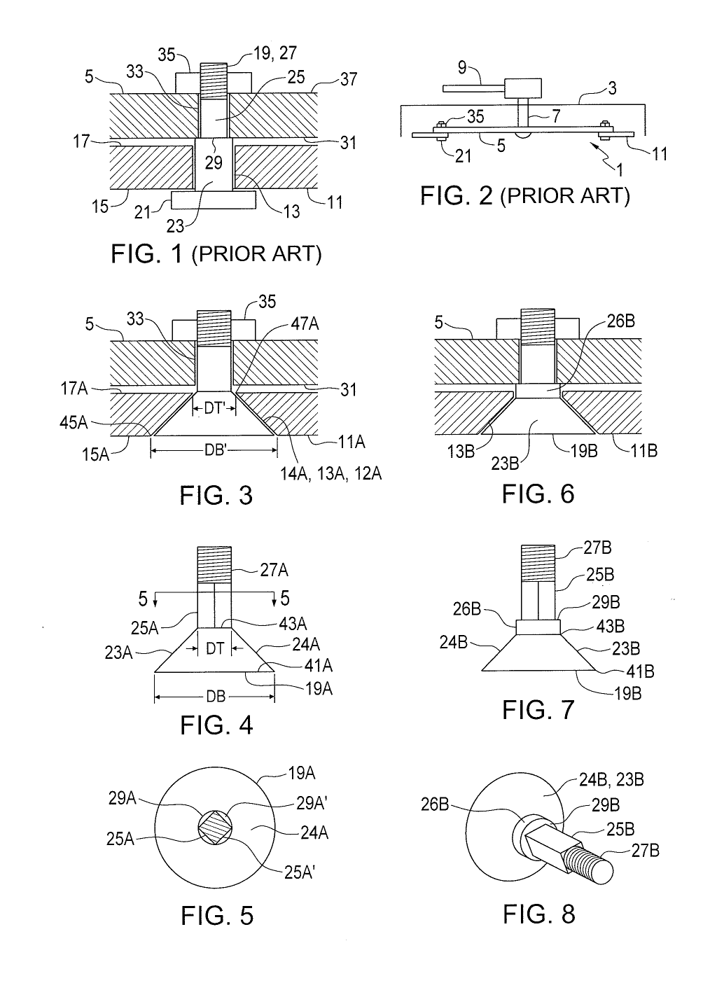

FIGS. 1 and 2 schematically illustrate a typical blade assembly 1 of the prior art for a rotary mower. The blade assembly 1 is mounted under a mower deck 3 and comprises a rotating blade carrier 5 connected to a vertical drive shaft 7 that is rotationally driven by a driveline 9 connected to a power source, such as a tractor towing the mower. A blade 11 defines a cylindrical blade mounting hole 13 extending substantially vertically from a bottom surface 15 of the blade 11 to a top surface 17 of the blade 11. A bolt 19 has a head 21 and shoulder section 23, shank section 25, and threaded section 27 extending from the shank section 25. The bolt 19 extends upward through the blade mounting hole 13 and the top edge 29 of the shoulder section 23 bears against the bottom surface 31 of the carrier 5 while the shank section 25 extends through a shank hole 33 in the carrier 5. The shank section 25 is slightly shorter than the thickness of the carrier 5 such that a nut 35 can threaded on the threaded section 27 of the bolt 19 above the top surface 37 of the carrier 5 and tightened to clamp the top edge 29 of the shoulder section 23 of the bolt 19 against the bottom surface 31 of the carrier 5 and fix the bolt 19 with respect to the carrier 5. The shank section 25 and shank hole 33 are configured as square, hexagonal, or the like with corresponding corners so that the shank section 25 is prevented from turning in the shank hole 33, thereby allowing the nut 35 to be tightened.

As can be seen, the thickness of the blade 11 between the bottom and top surfaces 15, 17 of the blade 11 is slightly less than the length of the shoulder section 23 is slightly longer than the. The blade 11 can thus pivot freely on the shoulder section 23 of the bolt 19 between the head 21 and the bottom surface 31 of the carrier 5.

The head 21 of the bolt 19 thus provides all the vertical support for the blade 11—without the head 21 the blade would fall down off the bolt 19 in response to gravity as well as in response to vertical forces exerted thereon by contact with vegetation being cut. The shoulder section 23 of the bolt 19 provides the horizontal support for the blade 11 while the blade 11 is subjected to centrifugal forces from the rotation of the blade carrier 5 and lateral forces from contact with vegetation being cut. While cutting vegetation the blade 11 is constantly moving on the bolt 19 in response to these forces, and so wear takes place on top surface of the head 21 and on the vertical walls of the shoulder section 23 of the bolt 19.

The head 21 of the bolt 19 is also subjected to wear from contact with vegetation being cut, as well as damage from stones and like debris commonly encountered during cutting operations. Although uncommon, it is known for the head 21 to be broken off by such contact and the blade 11 released and thrown at high speed, creating a significant hazard.

FIGS. 3-5 illustrate an embodiment of a bolt 19A of the present invention for attaching a blade 11A to a rotating blade carrier 5 of a rotary mower as shown in FIGS. 1 and 2. The bolt 19A comprises a conical shoulder section 23A at a bottom portion of the bolt 19A. A conical wall 24A of the shoulder section 23A tapers inward from a bottom edge 41A thereof to a top edge 43A thereof such that a diameter DB of the bottom edge 41A of the conical wall 24A is greater than a diameter DT of the top edge 43A of the conical wall 24A.

A shoulder top edge 29A is located above the conical shoulder section 23A. In the illustrated bolt 19A the top of the conical wall 24A bears against the bottom surface 31 of the carrier 5 and thus provides the top shoulder edge 29A of the illustrated bolt 19A. A shank section 25 of the bolt extends upward from the top shoulder edge 29A. As seen in FIG. 5, portions 29A′ of the top shoulder edge 29A extend laterally outward from portions 25A′ of the shank 25 to provide a surface that will bear against the bottom surface 31 of the carrier when the nut 35 is tightened on the threaded portion 27A of the bolt 19A that extends upward from the shank 25 at a top end of the bolt 19A. As seen in FIG. 5, the shank section 25A is configured with a square cross-section so same will not turn in a similarly shaped shank hole 33 through the carrier 5.

The embodiment of a blade 11A of the present invention for attachment to a rotating blade carrier 5 of a rotary mower comprises a top surface 17A and a bottom surface 15A, and defines a mounting hole 13A extending substantially vertically from the bottom surface of the blade to the top surface of the blade 11A. In the illustrated blade 11A, the entire mounting hole 13A provides a conical portion 12A with a conical wall 14A tapering inward from a bottom edge 45A thereof to a top edge 47A thereof, such that the bottom edge 45A of the conical wall has a diameter DB′ that is larger than the diameter DT′ of the top edge 47A of the conical wall 14A.

The conical wall 24A of the conical shoulder section 23A has substantially the same slope as the conical wall 14A of the of the blade mounting hole 13A such that the conical wall 24A of the conical shoulder section 23A bears against the conical wall 14A of the blade mounting hole 13A to support the blade 11A vertically and horizontally.

Basically from the top shoulder edge 29A upward through the shank 25 and threaded portion 27 the bolt 19A of the present invention is the same as the bolt 19 of the prior art. Below the top shoulder edge, the conventional bolt 19 has a circular cylindrical vertical shoulder 23 to horizontally support the blade 11, and a head 21 extending laterally out from the shoulder 23 to vertically support the blade 11.

In contrast in the bolt 19A, the tapered conical wall 24 of the conical shoulder portion 23A provides both vertical and horizontal support for the blade 11A, providing the functions of the vertical shoulder 23 and horizontal head 21 of the conventional bolt 19. The area of the vertical cylindrical shoulder 23, which bears against the walls of the vertical mounting hole 13, added to the area of the top side of the head 21 which bears against the bottom of the blade 11 to provide vertical support, is the total conventional support area supporting the blade 11 in the conventional bolt. The area of the conical walls 14A and 24A is greater than that total conventional support area, and thus provides a larger wearing surface, resulting in reduced wear.

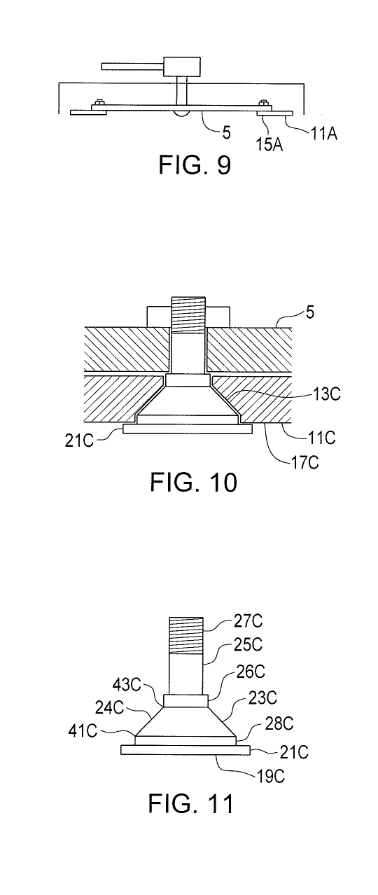

Further, no head is required below the bottom surface 15A of the blade 11A and so the risk of breaking off the head by contact with rocks or like debris is reduced. The bottom of the blade 11A when attached to the blade carrier 5 is flush, as illustrated in FIG. 9.

Thus the bolt 19A and blade 11A of the present invention provide a blade assembly 1A of the present invention for a rotary mower. The assembly 1A comprises a rotating blade carrier 5, and a blade 11 defining a blade mounting hole 13A extending substantially vertically from a bottom surface 17A of the blade 11A to a top surface 15A of the blade 11A with at least a portion of the blade mounting hole 13A being a conical portion 12A. A conical wall 14A of the conical portion 12A tapers inward from a bottom edge 45A thereof to a top edge 47A thereof, such that the bottom edge 45A of the conical wall 14A has a diameter DB′ that is larger than a diameter DT′ of the top edge 47A of the conical wall 14A.

The bolt 19A extends upward through the blade mounting hole 13A. The bolt 19A comprises a conical shoulder section 23A at a bottom portion of the bolt 19. The conical wall 24A of the conical shoulder section 23A has substantially the same slope as the conical wall 14A of the of the conical portion 12A of the blade mounting hole 13A such that the conical wall 24A of the conical shoulder section bears against the conical wall 14A of the conical portion 12A of the blade mounting hole 13A to support the blade 11A vertically and horizontally.

A shoulder top edge 29A above the conical shoulder section 23A bears against a bottom side 31 of the blade carrier 5 above the top surface 15A of the blade 11A such that the blade 11A pinots freely on the bolt 19. A shank 25A extends upward from the shoulder 29A edge through a corresponding shank hole 33 in the blade carrier 5. A threaded portion 27A extends upward from the shank 25A above a top side 37 of the blade carrier 5, and a nut 35 is threaded onto the threaded portion 27A of the bolt 19A and tightened to clamp the blade carrier 5 between the nut 35 and the shoulder top edge 29A of the bolt 19A.

FIGS. 6-8 schematically illustrate an alternate embodiment of a bolt 19B of the present invention for attaching a blade 11B to a rotating blade carrier 5 of a rotary mower as shown in FIGS. 1 and 2. The bolt 19B comprises a conical shoulder section 23B at a bottom portion of the bolt 19B with a conical wall 24B of the shoulder section 23B tapering inward from a bottom edge 41B thereof to a top edge 43B. A circular cylindrical shoulder section 26B with substantially vertical walls extends up from the top edge 43B of the conical wall 24B to the shoulder top edge 29B. The circular cylindrical shoulder section 26B has a diameter substantially equal to the diameter of the top edge 43B of the conical wall 24B. The shank section 25B and threaded section 27B are as described above. The mounting hole 13B in the blade 11B has corresponding conical and circular cylindrical sections as illustrated, and the attachment to the blade carrier 5 is as described above.

FIGS. 10 and 11 schematically illustrate a further alternate embodiment of a bolt 19C of the present invention for attaching a blade 11C to a rotating blade carrier 5 of a rotary mower as shown in FIGS. 1 and 2. The bolt 19C comprises a conical shoulder section 23C at a bottom portion of the bolt 19C with a conical wall 24C of the shoulder section 23C tapering inward from a bottom edge 41C thereof to a top edge 43C. A circular cylindrical shoulder section 26C with substantially vertical walls extends up from the top edge 43C of the conical wall 24C to the shoulder top edge 29C, and a second circular cylindrical shoulder section 28C with substantially vertical walls extends down from the bottom edge 41C of the conical wall 24C. The top and bottom circular shoulder sections 26C, 28C have diameters corresponding to the top and bottom edges 43C, 41C of the conical wall 24C.

The circular shoulder sections of the bolts 19B, 19C provide increased lateral support when conditions warrant same.

The shank section 25C and threaded section 27C are as described above. The mounting hole 13C in the blade 11C has corresponding conical and circular cylindrical sections as illustrated, and the attachment to the blade carrier 5 is as described above. The bolt 19C is also shown with a head 21C extending laterally from the bottom of the circular cylindrical section 28C, such that same is exposed below the lower surface 17C of the blade 11C. It is contemplated that such a head 21C may be desirable in some conditions by providing increased vertical support, further strengthening the bolt 19C, and/or facilitating mounting the blade 11C.

The present invention thus provides a bolt, blade, and blade assembly that provides an increased bearing surface supporting the blade with resultant reduced wear, and with a flush bottom surface of the mounted blade that reduces power requirements and the risk of damage.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A bolt for attaching a blade to a rotating blade carrier of a rotary mower, the bolt comprising:
a conical shoulder section at a bottom portion of the bolt, wherein a conical wall of the shoulder section tapers inward from a bottom edge thereof to a top edge thereof such that a diameter of the bottom edge of the conical wall is greater than a diameter of the top edge of the conical wall;
a shoulder top edge above the conical shoulder section;
a shank extending upward from the shoulder top edge, the shank configured to extend through a shank hole in the carrier, and at least a portion of the shoulder top edge extending laterally outward from at least a portion of the shank;
a threaded portion extending upward from the shank at a top end of the bolt.

2. The bolt of claim 1 wherein the shoulder top edge is provided by an upper portion of the conical wall.

3. The bolt of claim 1 comprising a circular cylindrical shoulder section with substantially vertical walls extending up from the top edge of the conical wall to the shoulder top edge.

4. The bolt of claim 1 comprising a circular cylindrical shoulder section with substantially vertical walls extending down from the bottom edge of the conical wall.

5. The bolt of claim 4 wherein the circular cylindrical shoulder section extending down from the bottom edge of the conical wall has a diameter substantially equal to the diameter of the bottom edge of the conical wall.

6. The bolt of claim 1 further comprising a head at a bottom end of the bolt below the bottom edge of the conical wall, the head having a diameter greater than the diameter of the bottom edge of the conical wall.

7. A blade for attachment to a rotating blade carrier of a rotary mower, the blade comprising a top surface and a bottom surface, and defining a mounting hole extending substantially vertically from the bottom surface of the blade to the top surface of the blade, wherein at least a portion of the blade mounting hole is a conical portion wherein a conical wall of the conical portion tapers inward from a bottom edge thereof to a top edge thereof, such that the bottom edge of the conical wall has a diameter that is larger than a diameter of the top edge of the conical wall.

8. The blade of claim 7 wherein the mounting hole further comprises a circular cylindrical portion with substantially vertical walls extending up from the top edge of the conical wall to the top surface of the blade.

9. The blade of claim 7 comprising a circular cylindrical shoulder section with substantially vertical walls extending down from the bottom edge of the conical wall to the bottom surface of the blade.

10. A blade assembly for a rotary mower, the assembly comprising:
a rotating blade carrier;
a blade defining a blade mounting hole extending substantially vertically from a bottom surface of the blade to a top surface of the blade with at least a portion of the blade mounting hole being a conical portion, wherein a conical wall of the conical portion tapers inward from a bottom edge thereof to a top edge thereof, such that the bottom edge of the conical wall has a diameter that is larger than a diameter of the top edge of the conical wall;
a bolt extending upward through the blade mounting hole, the bolt comprising:
a conical shoulder section at a bottom portion of the bolt wherein a conical wall of the conical shoulder section has substantially the same slope as the conical wall of the of the conical portion of the blade mounting hole such that the conical wall of the conical shoulder section bears against the conical wall of the conical portion of the blade mounting hole to support the blade vertically and horizontally;
a shoulder top edge above the conical shoulder section, the shoulder top edge bearing against a bottom side of the blade carrier above the top surface of the blade such that the blade pinots freely on the bolt;
a shank extending upward from the shoulder top edge through a corresponding shank hole in the blade carrier; and
a threaded portion extending upward from the shank above a top side of the blade carrier;
and
a nut threaded onto the threaded portion of the bolt and tightened to clamp the blade carrier between the nut and the shoulder top edge.

11. The assembly of claim 10 wherein the shoulder top edge is provided by an upper portion of the conical wall.

12. The assembly of claim 10 wherein the bolt and blade mounting hole comprise corresponding circular cylindrical shoulder sections with substantially vertical walls extending up from the top edge of the conical wall of the conical shoulder section.

13. The assembly of claim 10 wherein the bolt and blade mounting hole comprise corresponding circular cylindrical shoulder sections with substantially vertical walls extending down from the bottom edge of the conical wall of the conical shoulder section.

14. The assembly of claim 13 wherein the circular cylindrical shoulder sections extending down from the bottom edge of the conical wall of the conical shoulder section have a diameter substantially equal to the diameter of the bottom edge of the conical wall of the conical shoulder section.

15. The assembly of claim 10 further comprising a head at a bottom end of the bolt below the bottom edge of the conical wall of the conical shoulder section, the head having a diameter greater than the diameter of the bottom edge of the conical wall of the conical shoulder section.
